(19) United States
(12) Patent Application Publication
(10) Pub. No.: US 2016/0146510 A1
(43) Pub. Date: May 26, 2016

(54) HEATING MEDIUM COMPOSITION

(71) Applicant: JX NIPPON OIL & ENERGY CORPORATION, Tokyo (JP)

(72) Inventors: Takahiro KAWAGUCHI, Tokyo (JP); Tsutomu TAKASHIMA, Tokyo (JP)

(73) Assignee: JX NIPPON OIL & ENERGY CORPORATION, Tokyo (JP)

(21) Appl. No.: 14/900,197

(22) PCT Filed: Jul. 16, 2014
(86) PCT No.: PCT/JP2014/068949

§ 371 Date: Dec. 21, 2015

(30) Foreign Application Priority Data
Aug. 1, 2013 (JP) 2013-160506

(51) Int. Cl. F24J 2/46; C09K 5/10

(52) U.S. Cl. CPC F24J 2/4649; C09K 5/10

(57) ABSTRACT

A heating medium composition includes 5 to 40% by mass of biphenyl, 10 to 70% by mass of diphenyl ether, 5 to 30% by mass of diphenylene oxide, and 5 to 30% by mass of naphthalene.

### FIELD

The present invention relates to a heating medium composition.

### BACKGROUND

Heating media have been widely used in applications for, for example, heat removal in exothermic reactions at high temperatures, heat reservoirs, and solar thermal power generation, and are desired to be stable in a wide temperature range from ordinary temperatures to high temperatures. Aromatic hydrocarbon based heating medium compositions have been disclosed as such heating media, for example, heating medium compositions containing biphenyl and diphenyl oxide (diphenyl ether) (see Patent Literature 1, for example).

A composition containing diphenyl oxide (diphenyl ether) to which diphenylene oxide has been added has also been developed as a heating medium excellent in stability at high temperatures (see Patent Literature 2, for example). Patent Literature 2 discloses that the stabilizing action of diphenylene oxide used in the composition is also applicable to a eutectic mixture containing diphenyl ether to which diphenyl, naphthalene, or any other compound has been added.

A heating medium composition has also been disclosed in which diphenyl ether and benzophenone are mixed with at least one component selected from the group consisting of dibenzofuran (diphenylene oxide) and naphthalene at a given proportion (see Patent Literature 3, for example). Patent Literature 3 discloses that the heating medium composition can be further mixed with biphenyl.

It has also been disclosed that a heating medium made of a mixture of aryl compounds having two to five phenyl groups, for example, a 4-component mixture of biphenyl, diphenyl oxide (diphenyl ether), o-terphenyl, and m-terphenyl, or a 4-component mixture of biphenyl, naphthalene, o-terphenyl, and m-terphenyl, has excellent transportability with a pump at low temperatures because of depression of the freezing point (see Patent Literature 4, for example). Patent Literature 4 has also disclosed that dibenzofuran (diphenylene oxide) or the like may be incorporated into the heating medium in a small amount.

A heating medium composition made of biphenyl, diphenyl ether, and diphenylene oxide has also been disclosed. The heating medium composition has excellent heat resistance and easy handleability because of depression of the freezing point (see Patent Literature 5, for example).

### CITATION LIST

### Patent Literature

Patent Literature 1: Specification of U.S. Pat. No. 1,882,809
Patent Literature 2: Specification of U.S. Pat. No. 1,874,258
Patent Literature 3: U.S. Pat. No. H1393
Patent Literature 4: Japanese Patent Application Laid-open No. H01-261490
Patent Literature 5: Japanese Patent Application Laid-open No. H05-009465

### SUMMARY

### Technical Problem

Development needs of heating medium oils usable in a temperature region higher than conventionally employed temperatures have increased in recent years in applications for, for example, solar thermal power generation for the purpose of increasing electrical efficiency. Although the heating medium compositions containing the aromatic compounds disclosed in Patent Literatures 1 to 5 as main components have sufficient heat resistance at temperatures lower than 400° C., the compositions are not intended to be used at a temperature of 400° C. or higher. Their thermal stability is insufficient in the actual use at temperatures around 400° C. It is thus difficult to use the heating medium compositions in a higher temperature region. In addition, the heating medium compositions are not fluid at temperatures (ordinary temperatures) around 20° C. and thus are difficult to handle.

In view of the above-described disadvantages, it is an object of the present invention to provide a heating medium composition that is fluid at temperatures around 20° C., has easy handleability, and is excellent in heat resistance.

### Solution to Problem

The inventors of the present invention have found that a heating medium composition in which biphenyl, diphenyl ether, diphenylene oxide, and naphthalene are mixed together in given proportions is excellent in thermal stability even at 400° C. or higher and has excellent handleability because the composition is fluid even at ordinary temperatures, for example, around 20° C. The inventors have thus completed the present invention.

Specifically, a heating medium composition of the present invention contains 5 to 40% by mass of biphenyl, 10 to 70% by mass of diphenyl ether, 5 to 30% by mass of diphenylene oxide, and 5 to 30% by mass of naphthalene.

In the above invention, the heating medium composition of the present invention contains 5 to 30% by mass of biphenyl, 10 to 70% by mass of diphenyl ether, 5 to 25% by mass of diphenylene oxide, and 5 to 25% by mass of naphthalene.

In the above invention, the heating medium composition of the present invention contains 5 to 30% by mass of biphenyl, 10 to 60% by mass of diphenyl ether, 5 to 25% by mass of diphenylene oxide, and 5 to 25% by mass of naphthalene.

In the above invention, the heating medium composition of the present invention consists of biphenyl, diphenyl ether, diphenylene oxide, and naphthalene.

In the above invention, the heating medium composition of the present invention is used for solar thermal power generation.

### Advantageous Effects of Invention

The thermal stability of the heating medium composition of the present invention is not impaired at a high temperature of 400° C. or higher. The heating medium composition thus can be continuously used for a long period of time. Furthermore, the heating medium composition is fluid even at around 20° C., which makes it easy to handle. As described above, the heating medium composition has the highest heat resistant temperature among organic heating media and thus can be suitably used for, for example, heat removal in exothermic reactions at high temperature and heat reservoirs, and as a heating medium for solar thermal power generation.

### DESCRIPTION OF EMBODIMENTS

Preferable embodiments of the present invention are described in detail below. The present invention is not limited to the embodiments to be described.

The heating medium composition of the present invention contains 5 to 40% by mass of biphenyl, 10 to 70% by mass of diphenyl ether, 5 to 30% by mass of diphenylene oxide, and 5 to 30% by mass of naphthalene.

The inventors of the present invention have found that a heating medium composition containing biphenyl, diphenyl ether, diphenylene oxide, and naphthalene that are blended in given amounts is fluid even at temperatures (ordinary temperatures) around 20° C. and has excellent thermal stability even at high temperatures, for example, around 400° C.

The heating medium composition of the present invention contains biphenyl in an amount of 5 to 40% by mass, preferably, 5 to 30% by mass, and more preferably 10 to 30% by mass. When the content of biphenyl is smaller than 5% by mass, the proportions of the other components blended increase. As a result, the composition becomes likely to solidify and fails to be fluid at temperatures around 20° C. When the content of biphenyl is larger than 40% by mass, the proportion of biphenyl blended increases. As a result, the composition becomes likely to solidify as well and fails to be fluid at ordinary temperatures (around 20° C.)

The heating medium composition of the present invention contains diphenyl ether in an amount of 10 to 70% by mass, preferably, 10 to 60% by mass, and more preferably 20 to 50% by mass. When the content of diphenyl ether is smaller than 10% by mass, the proportions of the other components blended increases. As a result, the composition becomes likely to solidify and fails to be fluid at ordinary temperatures (around 20° C.). When the content of diphenyl ether is larger than 70% by mass, the proportion of diphenyl ether blended increases. As a result, the composition becomes likely to solidify as well and fails to be fluid at ordinary temperatures (around 20° C.)

The heating medium composition of the present invention contains diphenylene oxide in an amount of 5 to 30% by mass, preferably, 5 to 25% by mass, and more preferably 5 to 20% by mass. When the content of diphenylene oxide is smaller than 5% by mass, the proportions of the other components blended increases. As a result, the composition becomes likely to solidify and fails to be fluid at ordinary temperatures (around 20° C.)

When the content of diphenylene oxide is larger than 30% by mass, the proportion of diphenylene oxide increases. As a result, the composition becomes likely to solidify as well and fails to be fluid at ordinary temperatures (around 20° C.)

The heating medium composition of the present invention contains naphthalene in an amount of 5 to 30% by mass, preferably, 5 to 25% by mass, and more preferably 5 to 20% by mass. When the content of naphthalene is smaller than 5% by mass, the proportions of the other components blended increases. As a result, the composition becomes likely to solidify and fails to be fluid at ordinary temperatures (around 20° C.). When the content of naphthalene is larger than 30% by mass, the proportion of naphthalene increases. As a result, the composition becomes likely to solidify as well and fails to be fluid at ordinary temperatures (around 20° C.)

The heating medium composition of the present invention preferably consists of biphenyl, diphenyl ether, diphenylene oxide, and naphthalene. This is because the heating medium composition becomes fluid at ordinary temperatures (around 20° C.) and has excellent thermal stability at 400° C. or higher due to the blending of biphenyl, diphenyl ether, diphenylene oxide, and naphthalene in the afore-mentioned proportions. In the present specification, the expression “consists of biphenyl, diphenyl ether, diphenylene oxide, and naphthalene” does not exclude impurities derived from biphenyl, diphenyl ether, diphenylene oxide, and naphthalene.

The method of producing the heating medium composition of the present invention is not particularly limited, but biphenyl is typically produced from benzene as a raw material using a palladium catalyst. In the production of biphenyl from benzene, triphenyls, quaterphenyls, polyphenyls, and similar compounds that are produced as by-products of biphenyl may be contained in trace amounts. Diphenyl ether is typically produced by a bimolecular reaction between phenols using zeolite. Dibenzofuran phenylphenols, diphenylphenols, and similar compounds that are produced as by-products of diphenyl ether may be contained in trace amounts. Diphenylene oxide and naphthalene are contained in, for example, coal tar and can be obtained by distillation. Diphenylene oxide and naphthalene may contain methylnaphthalenes, dimethylnaphthalenes, fluorene, dibenzothiophene, acenaphthene, carbazole, phenyldibenzofurans, and similar compounds in trace amounts.

The heating medium composition of the present invention can be continuously used without having its thermal stability impaired at a high temperature of 400° C. or higher. The heat resistance of the heating medium composition can be evaluated by a thermal stability test at 430° C., for example. In the thermal stability test of the heating medium composition, the heating medium composition is charged into a sealable container, the inside of the container is filled with nitrogen, and the pressure in the container is adjusted to 2 MPa (room temperature). The container into which the heating medium composition has been charged is then maintained at 430° C. for 96 hours. The heat resistance of the heating medium composition is evaluated using the decomposition rate of the heating medium composition.

The decomposition rate of the heating medium composition of the present invention, obtained by the thermal stability test is preferably 2% or lower and more preferably 1.3% or lower. The decomposition rate of the heating medium composition can be measured by gas chromatography-mass spectroscopy. The proportions of liquid components produced after the thermal stability test can be evaluated from the decomposition rates measured in the manner to be described below. The following indicates an example of an analysis condition.
Apparatus: HP-6890
Column: J&W DB-1 (30 m×0.25 mmφ)
Carrier gas: helium
Injection volume: 0.2 μL

The decomposition rate is determined by an equation: Decomposition rate (%)=(Total sum of peak areas generated after test)/(Total sum of all of peak areas)×100

The melting point of the heating medium composition of the present invention is preferably 20° C. or lower. The melting point of 20° C. makes the handleability easy. Although the melting point is preferably 12° C. or lower, even when it exceeds 12° C., the heating medium composition can be used without any difficulty in combination with an auxiliary thermal insulation system such as a heat storage tank.

The heating medium composition of the present invention has the highest heat resistant temperature among organic heating media and thus is useful in, for example, heat removal in exothermic reactions at high temperatures, heat reservoirs, and as a heating medium for solar thermal power generation such as light concentrating solar thermal power generation. The heating medium composition of the present invention can be used as a heating medium for, for example, solar thermal power generation in a parabolic trough system. In the system, half-round collector mirrors concentrate sunlight on a pipe installed in front of the mirrors, whereby a heating medium flowing inside the pipe is heated, and vapor is produced using the heated heating medium for electric power generation. The heating medium composition is also usable in solar thermal power generation with a tower system. In this system, flat mirrors focus sunlight upon the solar collector in a tower installed in the central area to concentrate light, and the heat thus obtained is used for electric power generation. The boiling point of the heating medium composition of the present invention is about from 220 to 300° C. When the composition is used at a high temperature equal to or higher than the boiling point, pressure may be applied thereto.

### EXAMPLES

The embodiments of the present are exemplified in examples below, but the present invention is not limited to the examples.

The following compounds were used in the examples.

Biphenyl (BP, manufactured by Tokyo Chemical Industry Co., Ltd., a product with a purity of 99.5%)
Diphenyl ether (DPO, manufactured by Tokyo Chemical Industry Co., Ltd., a product with a purity of 99%)
Diphenylene oxide (DPNO, manufactured by Tokyo Chemical Industry Co., Ltd., a product with a purity of 97%)
Naphthalene (NA, manufactured by Tokyo Chemical Industry Co., Ltd., a product with a purity of 98%)
Dibenzothiophene (DBTP, manufactured by Tokyo Chemical Industry Co., Ltd., a product with a purity of 98%)
1-Phenylnaphthalene (1-PNA, Wako Pure Chemical Industries, Ltd., a product with a purity of 97%)
o-Triphenyl (o-TER, manufactured by Tokyo Chemical Industry Co., Ltd., a product with a purity of 99%)
m-Triphenyl (m-TER, manufactured by Tokyo Chemical Industry Co., Ltd., a product with a purity of 98%)

### Example 1

Biphenyl, diphenyl ether, diphenylene oxide, and naphthalene were blended together in the proportions (% by mass) in Table 1 to prepare a heating medium composition 1. A U-tube having an interior diameter of 14 mm, a width of 65 mm, and a height of 158 mm was filled with 20 g of the heating medium composition, the inside of the U-tube was filled with nitrogen, and the pressure in the U-tube was adjusted to 2 MPa. The heating medium composition was then subjected to a thermal stability test at 430° C. for 96 hours. The appearance of the heating medium composition before the test was visually identified at 12° C. and 20° C. (F: fluid, S: solid form observed). The heating medium composition after the test was measured by gas chromatography-mass spectroscopy to determine the decomposition rate (%). Table 1 lists the results. The heating medium composition 1 was fluid even at 12° C., and the decomposition rate after the thermal stability test was 1.2%.

### Examples 2 to 5

Biphenyl, diphenyl ether, diphenylene oxide, and naphthalene were blended together in the proportions (% by mass) in Table 1 to prepare heating medium compositions 2 to 5. Tests were performed in a similar manner to Example 1 except for the use of the prepared heating medium compositions 2 to 5. Table 1 similarly lists the results. In the heating medium composition 2, a solid form was observed at 12° C. while the heating medium compositions 3 to 5 were fluid even at 12° C. The decomposition rates of the heating medium compositions 2 to 5 after the thermal stability tests were from 1.0 to 1.3%, which reveals that the heating medium compositions 2 to 5 are excellent in thermal stability.

### Comparative Example 1

Biphenyl and dibenzothiophene were blended together in the proportions (% by mass) in Table 1 to prepare a heating medium composition 6. A test was performed in a similar manner to Example 1 except for the use of the prepared heating medium composition 6. Table 1 similarly lists the results. The heating medium composition 6 was found not to be fluid at 20° C.

### Comparative Example 2

Biphenyl and 1-phenylnaphthalene were blended together in the proportions (% by mass) in Table 1 to prepare a heating medium composition 7. A test was performed in a similar manner to Example 1 except for the use of the prepared heating medium composition 7. Table 1 similarly lists the results. Although the heating medium composition 7 was fluid at 20° C., the decomposition rate after the thermal stability test was found to be high.

### Comparative Example 3

Biphenyl and o-triphenyl were blended together in the proportions (% by mass) in Table 1 to prepare a heating medium composition 8. A test was performed in a similar manner to Example 1 except for the use of the prepared heating medium composition 8. Table 1 similarly lists the results. The heating medium composition 8 was found not to be fluid at 20° C.

### Comparative Example 4

A heating medium composition 9 was prepared in a formulation disclosed in Japanese Patent Application Laid-open No. H01-261490, that is, by blending biphenyl, diphenyl ether, o-triphenyl, and m-triphenyl together in the proportions (% by mass) in Table 1. A test was performed in a similar manner to Example 1 except for the use of the prepared heating medium composition 9. Table 1 similarly lists the results. The decomposition rate was 3.9%, which reveals that the thermal stability is lower than those of Examples 1 to 5.

### Comparative Example 5

Biphenyl, diphenyl ether, diphenylene oxide, and naphthalene were blended together in the proportions (% by mass) in Table 1 to prepare a heating medium composition 10. A test was performed in a similar manner to Example 1 except for the use of the prepared heating medium composition 10. Table 1 similarly lists the results. In the heating medium composition 10, biphenyl, diphenylene oxide, and naphthalene were blended in smaller amounts while diphenyl ether was blended in a larger amount than those of the present invention. The heating medium composition 10 was found not to be fluid at 20° C.

### Comparative Example 6

Biphenyl, diphenyl ether, diphenylene oxide, and naphthalene were blended together in the proportions (% by mass) in Table 1 to prepare a heating medium composition 11. A test was performed in a similar manner to Example 1 except for the use of the prepared heating medium composition 11. Table 1 similarly lists the results. The heating medium composition 11 in which biphenyl was blended in a larger amount than that of the present invention was found not to be fluid at 20° C.

### Comparative Example 7

Biphenyl, diphenyl ether, diphenylene oxide, and naphthalene were blended together in the proportions (% by mass) in Table 1 to prepare a heating medium composition 12. A test was performed in a similar manner to Example 1 except for the use of the prepared heating medium composition 12. Table 1 similarly lists the results. The heating medium composition 12 in which diphenylene oxide was blended in a larger amount than that of the present invention was found not to be fluid at 20° C.

### Comparative Example 8

Biphenyl, diphenyl ether, diphenylene oxide, and naphthalene were blended together in the proportions (% by mass) in Table 1 to prepare a heating medium composition 13. A test was performed in a similar manner to Example 1 except for the use of the prepared heating medium composition 13. Table 1 similarly lists the results. The heating medium composition 13 in which naphthalene was blended in a larger amount than that of the present invention was found not to be fluid at 20° C.

### Comparative Example 9

A heating medium composition 14 was prepared in a formulation disclosed in U.S. Pat. No. 1,874,258, that is, by blending diphenyl ether and diphenylene oxide together in the proportions (% by mass) in Table 1. A test was performed in a similar manner to Example 1 except for the use of the prepared heating medium composition 14. Table 1 similarly lists the results. The heating medium composition 14 as disclosed in U.S. Pat. No. 1,874,258 was found not to be fluid at 20° C.

### Comparative Example 10

A heating medium composition 15 was prepared in a formulation disclosed in Japanese Patent Application Laid-open No. H05-009465, that is, by blending biphenyl, diphenyl ether, and diphenylene oxide together in the proportions (% by mass) in Table 1. A test was performed in a similar manner to Example 1 except for the use of the prepared heating medium composition 15. Table 1 similarly lists the results. The heating medium composition 14 as disclosed in Japanese Patent Application Laid-open No. H05-009465 was found not to be fluid at 20° C.

TABLE 1

| | | | | | | | | | Decomposition | | |
|---|---|---|---|---|---|---|---|---|---|---|---|
| | | | | | | | | | rate | Appearance | |
| | BP | DPO | DPNO | NA | DBTP | 1-PNA | o-TER | m-TER | % | 12° C. | 20° C. |
| Example 1 | 26.2 | 36.6 | 18.3 | 18.9 | | | | | 1.2 | F | F |
| Example 2 | 33.5 | 14.6 | 26.6 | 25.3 | | | | | 1.0 | S | F |
| Example 3 | 19.5 | 60.5 | 5.0 | 15.0 | | | | | 1.3 | F | F |
| Example 4 | 25.0 | 35.0 | 20.0 | 20.0 | | | | | 1.3 | F | F |
| Example 5 | 26.5 | 53.0 | 10.7 | 9.8 | | | | | 1.3 | F | F |
| Comp. Ex. 1 | 26.5 | | | | 73.5 | | | | 2.1 | S | S |
| Comp. Ex. 2 | 26.5 | | | | | 73.5 | | | 4.7 | S | F |
| Comp. Ex. 3 | 26.5 | | | | | | 73.5 | | 1.5 | S | S |
| Comp. Ex. 4 | 15.9 | 44.1 | | | | | 30.0 | 10.0 | 3.9 | F | F |
| Comp. Ex. 5 | 4.6 | 86.7 | 4.0 | 4.6 | | | | | — | S | S |
| Comp. Ex. 6 | 42.0 | 20.0 | 20.0 | 18.0 | | | | | — | S | S |
| Comp. Ex. 7 | 20.0 | 25.0 | 35.0 | 20.0 | | | | | — | S | S |
| Comp. Ex. 8 | 30.0 | 20.0 | 15.0 | 35.0 | | | | | — | S | S |
| Comp. Ex. 9 | | 70.0 | 30.0 | | | | | | — | S | S |
| Comp. Ex. 10 | 32.0 | 48.0 | 20.0 | | | | | | 1.5 | S | S |

### INDUSTRIAL APPLICABILITY

The heating medium composition of the present invention can be continuously used at higher temperatures and thus is suitable for, for example, heat removal in exothermic reactions at high temperatures, heat reservoirs, and solar thermal power generation. The use of the heating medium composition of the present invention in these technical fields enables longer life spans, an increase in electrical efficiency, and a decrease in running costs.

1. A heating medium composition comprising:
5 to 40% by mass of biphenyl;
10 to 70% by mass of diphenyl ether;
5 to 30% by mass of diphenylene oxide; and
5 to 30% by mass of naphthalene.

2. The heating medium composition according to claim 1, wherein the heating medium composition comprises 5 to 30% by mass of biphenyl, 10 to 70% by mass of diphenyl ether, 5 to 25% by mass of diphenylene oxide, and 5 to 25% by mass of naphthalene.

3. The heating medium composition according to claim 1, wherein the heating medium composition comprises 5 to 30% by mass of biphenyl, 10 to 60% by mass of diphenyl ether, 5 to 25% by mass of diphenylene oxide, and 5 to 25% by mass of naphthalene.

4. The heating medium composition according to claim 1, wherein the heating medium composition consists of biphenyl, diphenyl ether, diphenylene oxide, and naphthalene.

5. The heating medium composition according to claim 1, wherein the heating medium composition is used for solar thermal power generation.

6. The heating medium composition according to claim 2, wherein the heating medium composition consists of biphenyl, diphenyl ether, diphenylene oxide, and naphthalene.

7. The heating medium composition according to claim 2, wherein the heating medium composition is used for solar thermal power generation.

8. The heating medium composition according to claim 3, wherein the heating medium composition consists of biphenyl, diphenyl ether, diphenylene oxide, and naphthalene.

9. The heating medium composition according to claim 3, wherein the heating medium composition is used for solar thermal power generation.

10. The heating medium composition according to claim 4, wherein the heating medium composition is used for solar thermal power generation.

11. The heating medium composition according to claim 6, wherein the heating medium composition is used for solar thermal power generation.

12. The heating medium composition according to claim 8, wherein the heating medium composition is used for solar thermal power generation.
